(19) United States
(12) Patent Application Publication
(10) Pub. No.: US 2009/0115626 A1
(43) Pub. Date: May 7, 2009

(54) Electronic meter for networked meter reading

(76) Inventors: Raj Vaswani, Portola Valley, CA (US); George Flammer, III, Cupertino, CA (US); Donn R. Dresselhuys, Shorewood, WI (US)

Correspondence Address: BUCHANAN, INGERSOLL & ROONEY PC, POST OFFICE BOX 1404, ALEXANDRIA, VA, 22313-1404, US

(21) Appl. No.: 11/979,449

(22) Filed: Nov. 2, 2007

(51) Int. Cl. G08B 23/00

(52) U.S. Cl. 340/870.02

(57) ABSTRACT

An automatic meter reading (AMR) data communication network for relaying meter commodity information includes a commodity provider node, a gateway node configured to communicate with the commodity provider node, and meter nodes configured to measure commodity characteristic data and communicate with the gateway node and with other meter nodes. A source node of the meter nodes generates a data packet that includes meter commodity information to be relayed to the commodity provider node, and when a first meter node of the meter nodes receives the source data packet, the first meter node relays the source data packet to a second node. The second node can include another meter node, a repeater node, the gateway node, or the commodity provider node. In an embodiment, the first meter node determines whether the data packet specifies a relay path for relaying the source data packet to the commodity provider node.

### CROSS-REFERENCE TO RELATED APPLICATIONS

This application is related to U.S. patent application Ser. No. 11/894,333, filed Aug. 21, 2007, which claims priority to U.S. patent application Ser. No. 10/672,781, filed Sep. 26, 2003, now U.S. Pat. No. 7,277,027, issued Oct. 2, 2007, which claims priority to U.S. patent application Ser. No. 09/242,792, filed Sep. 5, 1997, now U.S. Pat. No. 6,538,577, issued Mar. 25, 2003, the entire contents of all of which are hereby incorporated by reference.

### BACKGROUND OF THE INVENTION

Commodity usage is conventionally determined by utility companies using meters that monitor subscriber consumption. The utility service provider typically determines the subscriber's consumption by sending a service person to each meter location to manually record the information displayed on the meter dial. The manual reading is then entered into a computer which processes the information and outputs a billing statement for the subscriber. However, it is often difficult for the service person to access the meter for reading, inspection and maintenance. When access to a meter is not possible, billings are made on the basis of estimated readings. These estimated billings often lead to customer complaints.

Currently available electric meters such as watt-hour meters work well for their intended purpose, but they must be manually read. This makes it difficult to cost-effectively measure electricity usage for each user to promote fair billing and encourage conservation. Manual reading of electric meters is highly labor intensive, inefficient and very expensive. Therefore, there has been a strong interest on the part of utility companies to take advantage of modern technology to reduce operating costs and increase efficiency by eliminating the necessity for manual readings.

Many attempts have been made in recent years to develop an automatic meter reading system for electric meters which avoids the high costs of manual meter reading. However, most of these prior art systems have achieved little success. For automatic or remote meter reading, a transducer unit must be used with the meters to detect the output of such meters and transmit that information back to the utility.

Various types of devices have been attached to utility meters in an effort to simplify meter reading. These devices were developed to transfer commodity usage data over a communication link to a centrally located service center or utility. These communication links included telephone lines, power lines, or a radio frequency (RF) link.

The use of existing telephone lines and power lines to communicate commodity usage data to a utility have encountered significant technical difficulties. In a telephone line system, the meter data may interfere with the subscriber's normal phone line operation, and would require cooperation between the telephone company and the utility company for shared use of the telephone lines. A telephone line communication link would also require a hard wire connection between the meter and the main telephone line, increasing installation costs. The use of a power line carrier (PLC) communication link over existing power lines would again require a hard wire connection between the meter and the main power line. Another disadvantage of the PLC system is the possibility of losing data from interference on the power line.

Meters have been developed which can be read remotely. Such meters are configured as transducers and include a radio transmitter for transmitting data to the utility. These prior art systems required the meter to be polled on a regular basis by a data interrogator. The data interrogator may be mounted to a mobile unit traveling around the neighborhood, incorporated within a portable hand-held unit carried by a service person, or mounted at a centrally located site. When the meter is interrogated by a RF signal from the data interrogator, the meter responds by transmitting a signal encoded with the meter reading and any other information requested. The meter does not initiate the communication.

However, such prior art systems have disadvantages. The first disadvantage is that the device mounted to the meter generally has a small transceiver having a very low power output and thus a very short range. This would require that the interrogation unit be in close proximity to the meters. Another disadvantage is that the device attached to the meter must be polled on a regular basis by the data interrogator. The device attached to the meter is not able to initiate a communication. The mobile and hand-held data interrogators are of limited value since it is still necessary for utility service personnel to travel around neighborhoods and businesses to remotely read the meters. It only avoids the necessity of entering a residence or other building to read the meters. The systems utilizing a data interrogator at fixed locations still have the disadvantages of low power output from the devices attached to the meters, and requiring polling by the data interrogator to initiate communication.

Meters have been developed which can function as repeaters in automatic meter reading communication networks. The repeater meter can examine a received message for a meter protocol field that specifies whether the message is to be repeated. If the message is to be repeated, the meter retransmits the message for reception by other meters downstream or upstream. However, the repeater meter does not analyze or modify the specified downstream path or the upstream path. Collector devices have also been developed which can self-configure a metering network by periodically scanning for, and registering, meters that are operable to directly communicate with the collector. The collectors can also instruct the registered meters to scan for meters that are operable to directly communicate with the registered meters. While the meters may be able to switch collectors, they are not able to self-configure the metering network without the assistance of the collector(s).

Therefore, although automatic meter reading systems are known in the prior art, the currently available automatic meter reading systems suffer from several disadvantages, such as low operating range and communication reliability. Thus, it would be desirable to provide an electronic electric meter to retrofit into existing meter sockets or for new installations that enables cost effective measurement of electricity usage by a consumer. It would also be desirable to have an electric meter that is capable of providing automatic networked meter reading.

### SUMMARY OF THE INVENTION

The present invention relates to an apparatus for measuring usage of a commodity. More particularly, the invention relates to an electronic meter for measuring data regarding consumption of a commodity (e.g., electricity), and communicating data, such as commodity utilization data and other power information, to a commodity provider (e.g., a utility service provider or “utility”). The electronic meter can communicate the data over a two-way data communication network, such as a wireless local area network (LAN) using spread spectrum, to a remotely located gateway node. The gateway node can transmit the data over a two-way network, such as a fixed common carrier wide area network (WAN), to the utility, or may communicate the data directly to the utility over a commercially available two-way data communication network, such as a personal communication services (PCS) or a power line carrier (PLC) network.

An object of the present invention is to provide an integrated fully electronic electric meter that retrofits into existing meter sockets and is compatible with current utility operations.

A further object of the invention is to provide a gateway node with message format conversion capability, so that, for example, the gateway node can receive commodity utilization data and power quality information from the electric meter and transmit that data to a utility service provider over a commercially available fixed common carrier WAN, in a message format that is compatible with the WAN.

Yet another object of the invention is to provide an electronic electric meter that communicates commodity utilization data and power quality information upon interrogation by a communication node, such as a gateway node, at preprogrammed scheduled reading times, and by spontaneous reporting of tamper or power outage conditions.

Yet another object of the invention is to provide an electronic electric meter that is of a modular construction to easily allow an operator to change circuit boards or modules depending upon the desired data communication network.

A fully electronic electric meter for collecting, processing and transmitting commodity utilization and power quality data to a utility service provider is described herein.

The electronic electric meter may have a modular design allowing for the removal and interchangeability of circuit boards and modules within the meter. All of the circuit boards and modules plug into a common backplane or busing system.

A radio frequency (RF) transceiver located within the meter can be used to create a LAN link between the meter and a gateway node located remotely from the meter. This LAN may utilize a 900 MHz spread spectrum communication technique for transmitting commodity utilization data and power quality information from the meter to the gateway node, and for receiving interrogation signals from the gateway node, utilizing a message format that is compatible with the LAN and the WAN.

Alternatively, the electric meter may communicate with the utility via one or more intermediate relay nodes (e.g., other networked electric meters, also referred to herein as “meter nodes”), which relay data packets from a source node towards a gateway node which is the data target. The intermediate nodes may check the data packet header for the data target, reinstall the address of the data target, along with the source ID of the source node and the ID of the intermediate relay node, and transmit the packet to the next intended data target via the RF LAN. In some cases, the next intended data target may be another node. This relay configuration, and address headers, may be either pre-set by the source node or one of the intermediate nodes based on a relay table in the node's storage that is established with an analysis of link and path costs for reaching the gateway node for egress.

The relay function can sometimes depend on routing. For example, routing calculations at the source meter node, an intermediate node, or at the gateway may establish a relay path for a data packet that can be stored in a relay table. The relay path can include one or more hops so that, with each hop, the packet is forwarded to a next node (or to the gateway) in the path specified in the relay table. Similarly, packets targeted for a node in a utility network from the gateway, may traverse one or more hops, as prescribed by the relay table, or as set by any of the intermediate nodes. Any intermediate node in the utility network may replace a relay path established by the gateway or by the source node with a replacement relay path in the packet header if the intermediate node concludes that the packets cannot be safely delivered using the original relay table. Further, the decision making at nodes may be limited to a predefined number of nodes in the network based on node characteristics, robustness, reliability, etc.

In some embodiments, the electric meter may perform as a network repeater node. As such, the electric meter may not be linked to any physical electric meter and may not have any electronics to interface with the electric meter. The meter may just have LAN RF interfaces and a radio controller that allows it to act as a LAN network node. Thus, the meter will have a network ID address, and be able to receive packets from an electric meter node or from another repeater node and retransmit the packet to a destination (target) address indicated in the packet.

The electric meter may also communicate directly with the utility through the variety of commercially available communication network interface modules that plug into the meter's backplane or bus system. For example, these modules might include a narrowband PCS module or a PLC module. For these modules, a gateway node may not be necessary to complete the communication link between the meter and the utility.

The gateway node is located remotely from the meter to complete the LAN and may also provide the link to the utility service provider over a commercially available fixed two-way common carrier WAN. Thus, in some embodiments, the gateway node may be made up of four major components, including a WAN interface module, an initialization microcontroller, a spread spectrum processor and a RF transceiver. The gateway node is responsible for providing interrogation signals to the meter and for receiving commodity utilization data from an interface management unit for the LAN. The gateway node, in creating a WAN message to the utility or an interrogation message to the meter, may adjust the format of the message to a format that is compatible with the WAN or the LAN.

In certain embodiments, any node in the wireless LAN may act as a gateway and contain the functional elements of the gateway described herein. In this capacity, any node acting as a gateway may conduct the functions of receiving, transmitting, relaying, formatting, routing, addressing, scheduling, and storing of messages transiting between any node in the wireless LAN to any other node in the wireless LAN or to the utility network that is based in a WAN to which the gateway is also connected.

The RF transceiver of the gateway node may transmit interrogation signals from the utility or preprogrammed signals for scheduled readings to the electric meter using a message format that is compatible with the LAN, and receive commodity utilization data in return from the meter for transmission to the utility over the WAN using a message format that is compatible with the LAN or the WAN. If the received message format at the gateway from the electric meter is in the LAN message format, then a WAN handler and a message dispatcher at the gateway can be used to convert the message format to the WAN format, including adjustments of address headers, payload fields, and other parameters. The spread spectrum processor may be coupled to the RF transceiver and enables the gateway node to transmit and receive data utilizing the spread spectrum communication technique. The WAN interface module may be coupled to the spread spectrum processor and transmits data to and from the utility service provider over any commercially available WAN that is desired. A different WAN interface module may be used for each different commercially available WAN desired. The initialization microcontroller may be interposed between the WAN interface module and the spread spectrum processor for controlling operation of the spread spectrum processor and for controlling communication within the gateway node.

The RF transceiver of the gateway node may communicate the interrogation and control signals and other requests to the intended node (e.g., meter) in the RF LAN via one or more intermediate nodes, which relay the gateway packets towards the intended node by receiving the gateway packets directly from the gateway or via one or more intermediate nodes, checking the identification of the data (packet) target, recreating the header with the target node ID and any intermediate node IDs, and retransmitting the packet via its RF transceiver.

The gateway may utilize a relay table stored in its data store and the message dispatcher in creating the packet headers for the interrogation, control, and other messages to the target node. As a result, a direct path to the target node from the gateway, or an indirect path via one or more intermediate nodes in the RF LAN may be provided. The gateway's relay table for packet delivery to/from each of the nodes may be continually developed and refined utilizing data from packets received from nodes of the RF LAN, and via an analysis of link and path costs to each of the nodes.

Meter reading, meter information management and network communications may all be controlled by two-way system software that is preprogrammed into the meter's memory during manufacture and installation. Such software enables an operator to program utility identification numbers, meter settings and readings, units of measure and alarm set points, among other data.

### BRIEF DESCRIPTION OF THE DRAWINGS

FIG. 1 is a perspective view of an electronic electric meter in accordance with the present invention;

FIG. 2 is a cross-sectional view of the internal structure of the electric meter shown in FIG. 1;

FIG. 3 is a block diagram of the electric meter circuitry;

FIG. 4 is a front elevational view of a gateway node;

FIG. 5 is a schematic view of the electric meter interfacing with a remote gateway node and a utility service provider, creating a networked automatic meter reading data communication system;

FIG. 6A is a flow diagram of one embodiment of the automatic meter reading data communication system shown in FIG. 5;

FIG. 6B is a flow diagram of another embodiment of the automatic meter reading data communication system shown in FIG. 5;

FIG. 6C is a flow diagram of yet another embodiment of the automatic meter reading data communication system shown in FIG. 5;

FIG. 7 is a block diagram of the gateway node circuitry;

FIG. 8 is a functional block diagram of the automatic meter reading data communication system of FIGS. 5 and 6A;

FIG. 9A is a flow diagram of the WAN handler portion of the data communication system of FIG. 8;

FIG. 9B is a flow diagram of the message dispatcher portion of the data communication system of FIG. 8;

FIG. 9C is a flow diagram of the RF handler portion of the data communication system of FIG. 8;

FIG. 9D is a flow diagram of the scheduler portion of the data communication system of FIG. 8; and

FIG. 9E is a flow diagram of the data stores portion of the data communication system of FIG. 8.

### DETAILED DESCRIPTION OF THE INVENTION

### Electronic Electric Meter

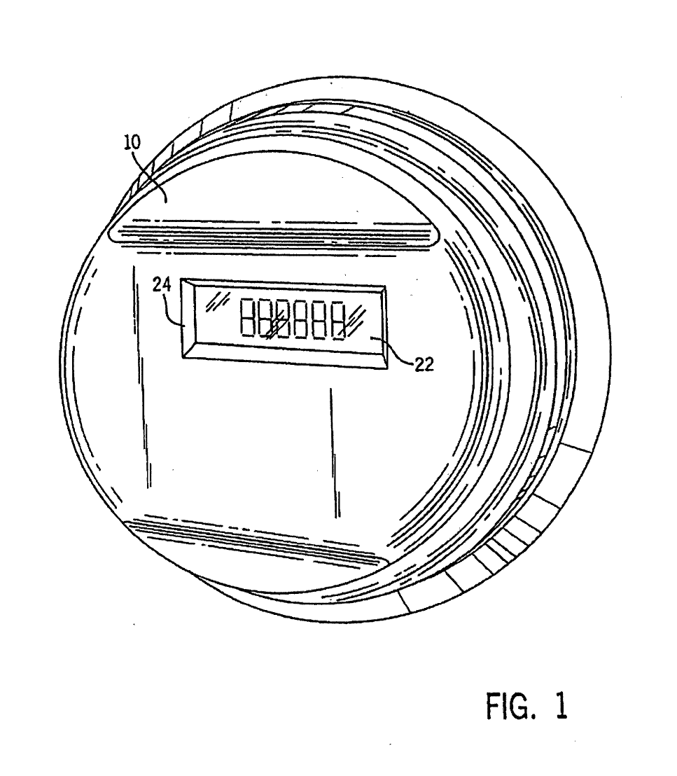

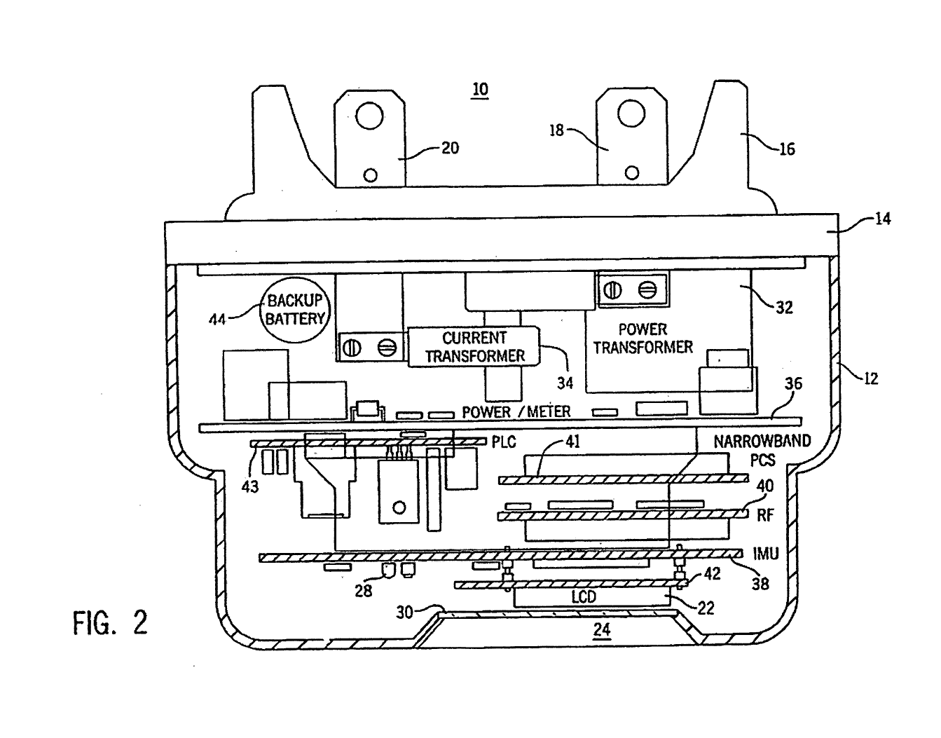

FIGS. 1 and 2 show a fully integrated, self-contained electronic electric meter 10 for measuring electricity usage and monitoring power quality. The meter 10 is operable for both single phase and three phase electric power installations. The meter 10 includes a top cover 12 attached to a meter base 14. Extending outwardly from the meter base 14 is a mounting frame 16 and a pair of terminals 18, 20. The meter 10 easily retrofits into existing meter sockets by insertion of terminals 18, 20 into the sockets and interlocking the mounting frame to secure the meter in place. The terminals 18, 20 complete the connection between the electric power line and the meter 10. The meter 10 further includes a liquid crystal display (LCD) 22 for displaying meter readings and settings, units of measure and status conditions. The top cover 12 includes a rectangular opening 24 for the LCD 22. A transparent piece of glass or plastic, which fits the shape and size of the display opening, covers the opening 24 for viewing LCD 22. In the embodiment shown in FIG. 1, the glass or plastic has a rectangular shape.

As shown in FIG. 2, the fully electronic, self-contained, modular electric meter 10 includes several electronic sub-assemblies. The sub-assemblies include a power transformer 32, a current transformer 34, a power/meter circuit board 36, an interface management unit circuit board 38, a radio frequency (RF) transceiver sub-assembly 40, an LCD sub-assembly 42, and a variety of commercially available plug-in network modules, such as a narrowband personal communication services (PCS) module 41 and a power line carrier (PLC) module 43. In practice, the electric meter 10 may only have one of the aforementioned plug-in network modules. The PCS module 41 may be a cellular communications module (e.g., CDMA-EVDO, CDMA1x, CDMA2000, WCDMA, GPRS, EDGE, among others).

All of the circuit boards and modules plug into a common backplane or busing system (not shown) providing a modular construction allowing for interchangeability of circuit boards and modules depending on the data communication network desired. While the meter 10 is shown as an electric meter, the meter 10 can also be configured to measure other physical characteristics/commodities such as water and gas. Other types of communications modules can be easily integrated.

### Circuitry of Electronic Electric Meter

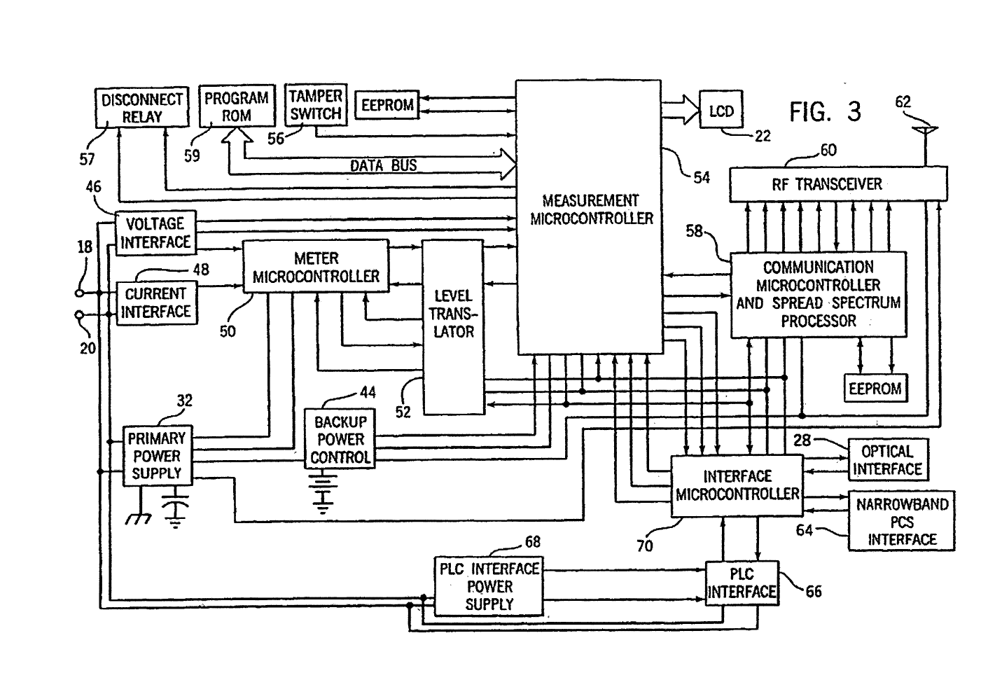

FIG. 3 shows a block diagram of the electric meter's internal circuitry. The meter 10 is powered directly from the electric power line coming through terminals 18, 20 and into power transformer 32 to provide the DC power required of the meter circuitry. Back up battery power 44 is provided in case of electrical power outages.

The electrical power flowing through terminals 18 and 20 is sensed by voltage interface transducer 46 and current interface transducer 48. The accumulated pulse totalization from transducers 46 and 48 is input into meter microcontroller 50 which interprets the electrical signal data received from transducers 46 and 48. The processed electrical signal data is then sent through a level translator 52 to condition the signals for the required input into measurement microcontroller 54. Measurement microcontroller 54 performs additional calculations on the electrical signals received from meter microcontroller 50 and prepares them for output to the LCD 22 or an appropriate communication network. Meter microcontroller 50 may comprise the integrated circuit sold by SAMES of South Africa under the designation SA9603B. The measurement microcontroller 54 may be an SMOS chip available under the designation SMC AA316F03.

The measurement microcontroller 54 also monitors inputs from tamper switch 56 and disconnect relay 57 for disconnecting the meter from the electrical line. The program ROM 59 contains customer specific and site specific variables that may be important for calculating electricity usage. The meter 10 has an accuracy of approximately 0.2% for a power input current range of 0-200 amps. Other features that the measurement microcontroller 54 is able to measure are kilowatt hour usage, voltage and frequency measurements, energy direction, time and date reporting, load profiling and failure reporting. The power/meter circuit board includes measurement microcontroller 54, level translator 52, meter microcontroller 50, backup battery 44, and primary power supply 32.

Electric meter 10 is able to communicate commodity utilization data and power quality information to a utility over a local area network (LAN) or a wide area network (WAN). A RF communication section within the electric meter 10 is comprised by a communication microcontroller and a spread spectrum processor chip 58 and a RF transceiver 60. An antenna 62 is coupled to the RF transceiver 60 for transmitting and receiving RF spread spectrum signals.

The communication microcontroller portion of chip 58 is responsible for all aspects of RF communication management in electric meter 10 including determining the presence of a valid interrogating signal from a remotely located gateway node, a utility server, or an authorized intermediate relay node. The communication microcontroller portion of chip 58 provides control information to spread spectrum processor portion of chip 58 and RF transceiver 60 to control spread spectrum protocol and RF channelization. Communication microcontroller and spread spectrum processor chip 58 may comprise the integrated circuit sold by Siliconians of California, under the designation SS105.

The spread spectrum communication technique makes use of a sequential noise-like signal structure, for example, pseudo-noise (PN) codes to spread a normally narrowband information signal over a relatively wide band of frequencies. This spread spectrum communication technique may be further understood by reference to U.S. Pat. No. 5,166,952 and the numerous publications cited therein.

The use of the spread spectrum communication technique, when used in conjunction with the direct sequence modulation technique, hereinafter described, gives the LAN data communication system a measure of security. This communication technique also avoids the need to obtain licensure from governmental authorities controlling radio communication. Other modulation schemes, such as frequency-hopping spread spectrum scheme and orthogonal frequency division multiple access scheme, may also be used.

The spread spectrum processor portion of chip 58 functions to perform spread spectrum encoding of the data from communication microcontroller provided to RF transceiver 60 and decoding of the spread spectrum data from the RF transceiver. A better understanding of the spread spectrum communication technique can be obtained by reading the subject matter described herein under the subheading entitled “Circuitry of Gateway Node”. The RF transceiver 60 and communication microcontroller and spread spectrum processor chip 58 are part of the circuitry on interface management unit board 38 and RF module 40 of FIG. 2.

The meter 10 may also include plug-in interface modules which correspond to a variety of different commercially available LAN or WAN communication devices. These communication devices provide a communication link directly from the electric meter 10 to a utility service provider. For example, shown in FIG. 3, is a narrowband PCS interface module 64, and a PLC interface module 66 powered by a PLC interface power supply 68. These communication interface modules are easily interchangeable within electric meter 10. The PCS module 41 of FIG. 2 (or 64 of FIG. 3) may be a cellular communications module (e.g., CDMA-EVDO, CDMA1x, CDMA2000, WCDMA, GPRS, EDGE, among others).

These modules communicate with the measurement microcontroller 54 and an interface microcontroller 70 along a common backplane or busing system (not shown). An exemplary meter interface includes the PowerPoint electronic meter interface for the GE KVII meter equipped with an internal antenna, or the GE KVII meter equipped with external antenna. When the meter 10 is configured to measure water or aqueous characteristics, a water interface management unit (IMU) interface such as the Silver Spring Network water IMU can be used. When the meter 10 is configured to measure gaseous characteristics, the Silver Spring Network gas IMU is an exemplary interface. Other exemplary interfaces include MTC Raven communications package V2.2, Siemens S4 communication package V2.2, or Schlumberger Vectron communication package V2.2.

In some embodiments, the electric meter 10 may simply perform as a network repeater node in the LAN, being able to transmit/receive messages over the LAN from other electric meters 10 or other electric meters performing as network repeater node. In this embodiment, the electric meter 10 may include communication microcontroller 58, storage, power supply 32, and related electronics that allow it to send and receive RF messages, check data packets, analyze and reconstruct data packet headers, store routing information, and format packets. Further, in this embodiment, the electric meter 10 may not include any electronics required for interfacing with the physical electric meter, including measurement microcontroller 54, LCD 22, meter microcontroller 50, level translator 52, tamper switch 56, voltage interface 46, current interface 20, tamper switch 56, program ROM 59, and disconnect relay 57, but will retain all necessary RF interfaces to communicate with other nodes and the gateway in the RF network. The meter as a repeater module may also be packaged differently. For example, some repeater nodes may be mounted on poles and have a housing that is compatible with the poletop environment, power, and physical space.

### Networked Automatic Meter Reading Data Communication System

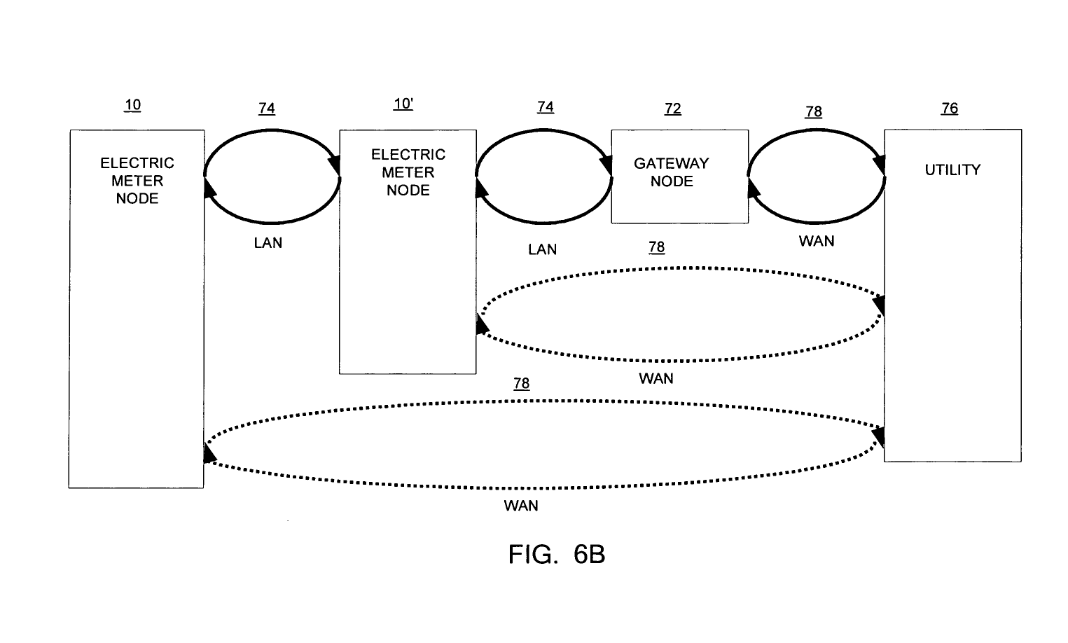

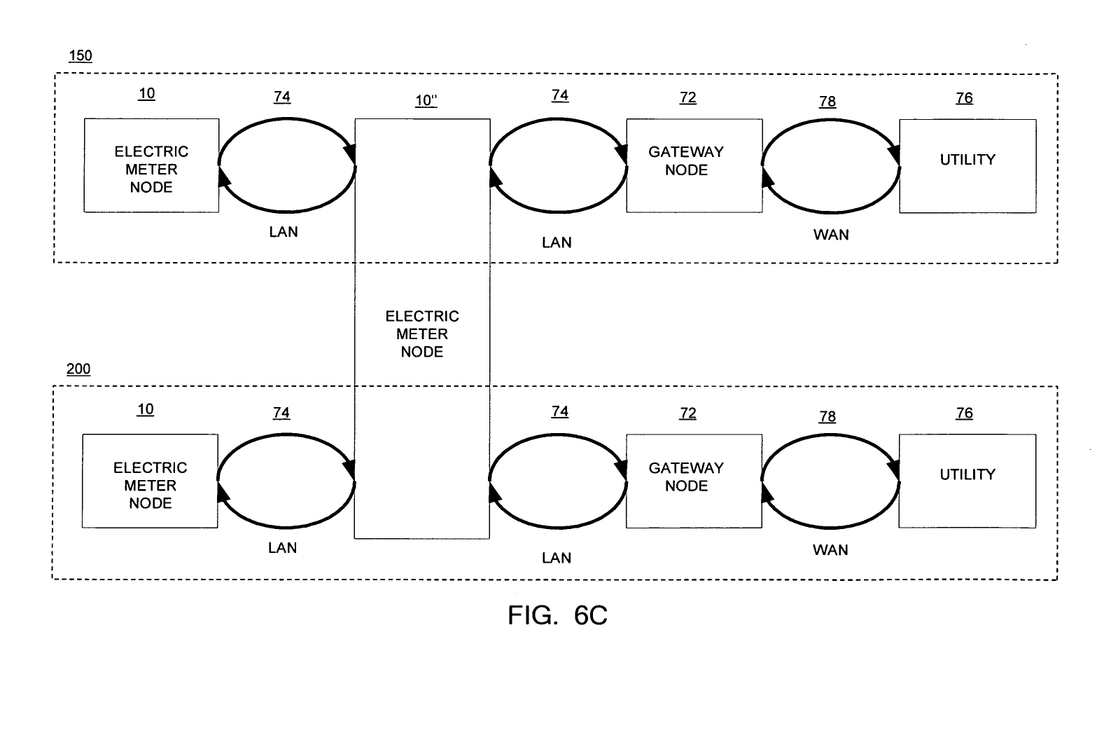

In an embodiment, shown in FIGS. 5 and 6A, the electric meter 10 communicates over a LAN 74 to a gateway node 72 which transmits the commodity data from the electric meter 10 to a utility 76 over a fixed common carrier WAN 78. The gateway node 72 acts as the agent for the exchange of messages between the meter 10 and the utility 76. Further, as described herein, the gateway 72 may transform the format of the messages to the electric meter 10 from the utility 76 and/or from the electric meter 10 to the utility 76 so that the message format(s) is compatible with the network traversed by the messages (e.g., the LAN or the WAN). The gateway node 72, therefore, provides the end-to-end communication links from the meter 10 to the utility 76. A first link in the data communication system illustrated in FIG. 6A is a two-way 900 MHz spread spectrum LAN 74. The second link within the data communication system is designed to be any commercially available two-way common carrier WAN 78. In this embodiment, a gateway node 72 must be within the communication range of the electric meter 10 which is approximately one mile.

In an alternative embodiment, shown in FIG. 6B, the electric meter 10 (also referred to as an electric meter node) communicates over the LAN 74 to the gateway node 72 via one or more intermediate electric meters 10′ (also referred to as intermediate relay nodes), and the gateway node 72 conveys the messages to the utility 76 over the WAN 78. The route for relaying the data packets to the gateway 72 via the one or more intermediate nodes 10′ may be pre-selected and set by the source electric meter 10, based on a relay table the source meter 10 has established and stored in its memory, or may be determined by the intermediate node 10′ which relays the packets to the gateway 72 directly or via one or more additional intermediate nodes 10′, based on relay table information the intermediate node 10′ has established and stored in its memory.

That is, the intermediate node 10′ may select the relay path provided by the source node and specified, for example, in the packet header, or may select the relay path determined by the intermediate node 10′, itself. The intermediate node 10′ may make the selection based on the relay table information stored in its memory, or based on the latest information on network conditions that it is able to ascertain by listening to packet traffic in progress. In one embodiment, the intermediate node 10′ may select the next node in the route to the gateway and replace only the next node in the relay path provided by the source node with its own selection of the next node. In another embodiment, the intermediate node 10′ may replace the entire relay path provided by the source node with its own relay path. In yet another embodiment, the source node may not have specified a relay path in the packet header, in which case, the intermediate node 10′ determines the relay path.

The relay table information may be based on routing calculations and may include one or more of the following: lowest path cost, lowest link cost(s), established reliability of the direct or multi-hop route based on past performance, known network conditions, or other information. For example, because power is a scarce commodity in automatic meter reading networks, nodes try to maintain low power transmissions. Further, in some networks, there are relays and selected nodes which have battery back up (i.e., reliable) and also, in some cases, have higher gain transmit antennas (i.e., higher power). A source node may prefer to relay its transmissions via one of these “reliable” and “higher power” nodes for further relay upstream. As network protocol, the network nodes may already have received information from such higher power nodes regarding whether to solicit requests for packet relay from “neighboring” network nodes (e.g., nodes with which the network node has a direct communication link). Utilizing this information, the source node may select an intermediate node for its transmissions.

Thus, routing calculations at the source meter node 10, an intermediate meter node 10′, or at the gateway 72 may establish for a data packet a relay path having one or more hops so that, with each hop, the data packet is forwarded to a next node (or to the gateway) in the path specified in the relay table. Similarly, packets targeted for a node in the network from the gateway 72, may traverse one or more hops, as prescribed by the relay table, or as set by any of the intermediate nodes 10′. Any intermediate node 10′ in the network may replace a relay path established by the gateway 72 or by the source node 10 with a replacement relay path by modifying the packet header if the intermediate node 10′ concludes that the packets cannot be safely delivered using the original, or previously specified, relay table. In one embodiment, the intermediate node 10′ may replace only the next node in a relay path established by the source node 10, gateway 72, or by another intermediate node 10′ with a replacement next node by modifying the packet header if the intermediate node 10′ concludes that the packets cannot be safely delivered using the original, or previously specified, next node in the relay table.

Further, the decision making at nodes may be limited to a predefined number of nodes in the network based on node characteristics, robustness, reliability, etc. For example, not all network nodes may be authorized to make such decisions on behalf of a source node. During initialization of the network, registration with the gateway and neighboring nodes, each network node may select “preferred neighbors” to which to relay packets and may make its own decisions for relaying packets upstream/receiving packets downstream. In selecting its preferred neighbors, a network node may use criteria such as robustness of the neighboring nodes, path costs and link costs, time being in operation, etc. Alternatively, at the node's request, the gateway may assign the preferred neighbors to each network node based on the gateway's network records, application of traffic distribution algorithms, etc.

In an embodiment, one or more of the intermediate nodes 10′ may be a lower-intelligence node that ignores or bypasses a relay path that is specified in the data packet and instead relays the data packet to a higher-intelligence intermediate node 10′ that acts as a problem-solver or fixer node. The higher-intelligence intermediate node 10′ can recognize and process the relay path specified in the data packet and/or can make its own decisions for relaying packets upstream/receiving packets downstream. For example, the lower-intelligence network node may be able to identify a higher-intelligence network node based on a network protocol that advertises in advance the functionalities of the different nodes in the network, or the lower-intelligence may have information that another node in the network is a higher-intelligence node, or the lower-intelligence may simply make a best guess at selecting a higher-intelligence node to which to relay the data packet.

In some embodiments, one or more of the intermediate nodes 10′ may simply perform as network repeater nodes, being able to transmit/receive messages from other nodes but not including any of the electronics required for interfacing with a physical electric meter.

Moreover, in the embodiment shown in FIG. 6B, a node 10′ that receives packets from the gateway 72 may be the target node (i.e., the intended or destination node). The receiving node 10′ determines whether it is the target node by checking the target address of a received packet and comparing the target address with the receiving node's ID address. If the addresses match, the receiving node 10′ proceeds to process the information received in the packet. If the addresses do not match, the receiving node 10′ checks the target node address, and retrieves a path for relaying the packet to the target node from its relay table. Alternatively, the gateway 72, itself, may provide a relay path in the form of a string of serial addresses in the packet header to direct the receiving node 10′ to retransmit the packet to the next node identified in the sting of serial addresses in the packet header after deleting the receiving node's ID address.

In another embodiment, shown in FIG. 6C, one or more nodes in one automatic meter reading data communication network 150 may be transmitting data to another node, gateway or utility server in another automatic meter reading data communication network 200 via one or more intermediate electric meter nodes 10″ that belong to both networks. The intermediate nodes 10″ have appropriate RF and network interfaces that enable them to communicate with nodes in both networks and to receive packets in formats used by the network nodes that they are receiving the data from. Further, the intermediate nodes 10″ may have the capability to transform data formats from formats used in the network 150 to formats used by the network 200, and vice versa. For example, the network 150 may be using one of zigbee, 6LowPAN, non-TCP/IP, or TCP/IP protocols, while the network 200 may be using another one of the zigbee, 6LowPAN, non-TCP/IP, and TCP/IP protocols. In this way, the intermediate nodes 10″ may maintain data packet format compatibility with the nodes from which they are receiving data packets and the nodes to which they are transmitting data packets.

For example, the intermediate nodes 10″ may belong to multiple In-Premise (IN-PREM) networks, and may relay packets from/to nodes in the different IN-PREM networks. An IN-PREM network may include nodes capable of communicating with in-premise devices (i.e., devices within the home or neighboring homes) through multiple protocols and communication technologies. In this example, an IN-PREM network may use one or more intermediate nodes 10″ in its network to communicate with nodes of other IN-PREM networks to which the intermediate nodes 10″ belong and/or to communicate with nodes that belong to a WAN, a utility network, or other network.

In another embodiment, the electric meter 10 may provide direct network access through printed circuit board sub-assemblies installed in meter 10, as described herein. Such sub-assemblies may include a LAN communications interface module, a WAN communications interface module, a PCS communications interface module, or a PLC communications interface module. For example, as shown in FIG. 6B, source electric meter node 10 and intermediate electric meter node 10′ may provide direct connections over the WAN 78 to the utility 76.

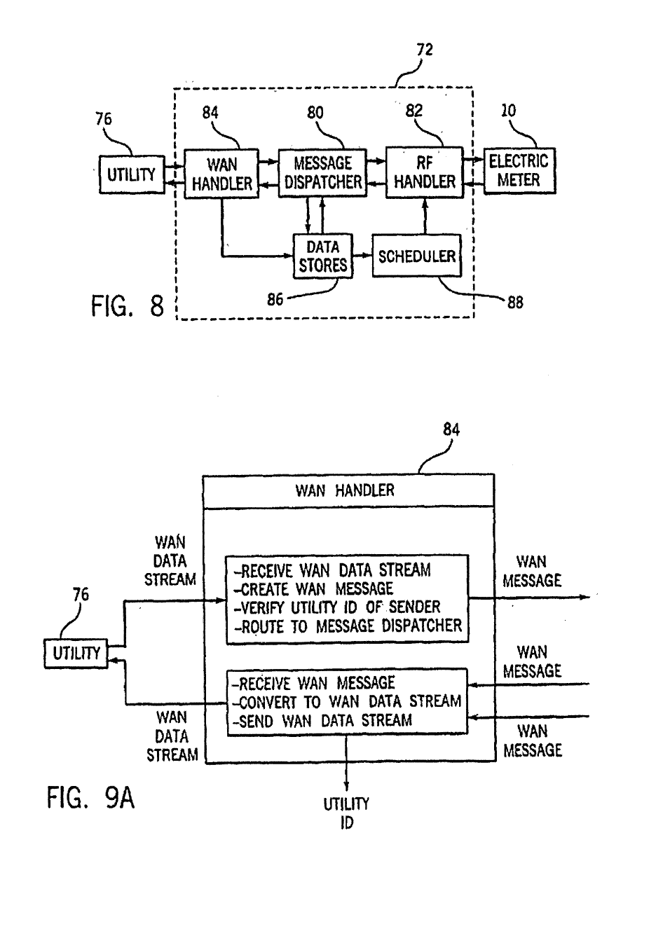

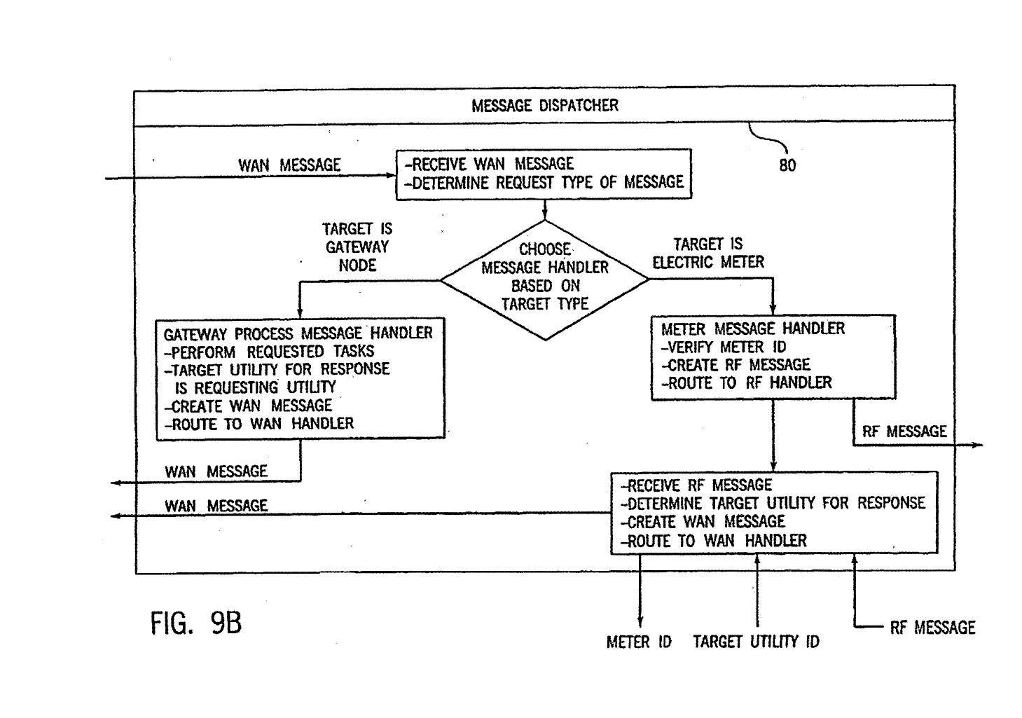

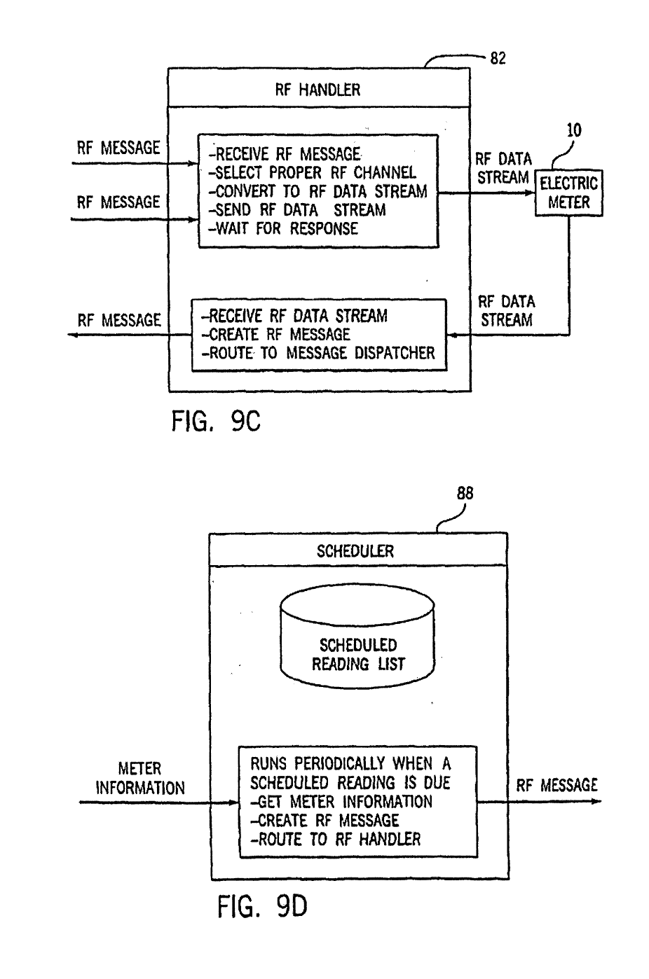

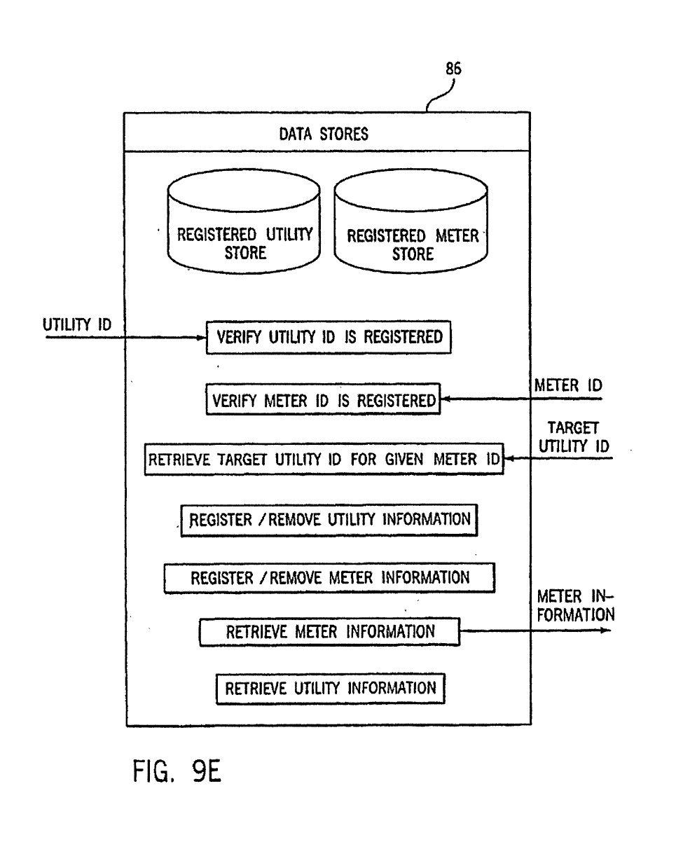

A more detailed representation of the networked automatic meter reading data communication systems of FIGS. 5 and 6A is shown in FIGS. 8 and 9A-9E. FIG. 8 shows a functional flow diagram of the networked automatic meter reading data communication system in which the components are described as functional blocks. The flow diagram of FIG. 8 illustrates the main functional components of the gateway node 72 which include a message dispatcher 80, a RF handler 82, a WAN handler 84, a data stores component 86 and a scheduler component 88. The data stores and scheduler components 86 and 88 comprise data that is regularly preprogrammed into the gateway node's memory. The gateway node 72 interfaces with the electric meter 10 over the two-way wireless LAN 74. The gateway node 72 also interfaces with the utility service provider 76 over the fixed common carrier WAN 78.

Each of the gateway components identified in FIG. 8 is described in detail with reference to FIGS. 9A through 9E. In some embodiments, the WAN handler 84, message dispatcher 80, scheduler 88, data stores 86, and RF handler 82, may be located anywhere in the wireless LAN 74 along with appropriate interfaces. In these embodiments, the distributed architecture along with appropriate interfaces, will provide the gateway functional support to the nodes 10 in the wireless LAN 74, which may be a variety of utility meters (e.g., water, gas, and electric), and provide two-way access to each node with the utility service provider 76 (e.g., network server or utility provider node) located in the WAN 78.

FIG. 9A is a detailed functional diagram of the WAN handler 84 of FIG. 8. In a typical communication episode, the utility 76 may initiate a request for data from the electric meter 10 by sending a data stream over the WAN 78. The WAN handler 84 of the gateway node 72 receives the WAN data stream, creates a WAN message, verifies the utility ID of the sender from the data stores 86 and routes the WAN message to the message dispatcher 80 in the gateway node.

In creating the WAN message, the WAN handler 84 retrieves from the data stores 86 information regarding the characteristics of the WAN and the LAN. For example, the WAN may be a TCP/IP network and the message format of WAN messages will be in TCP/IP format. The LAN may or may not be a TCP/IP network. If the LAN is also a TCP/IP network, the message format will stay the same, except some information in the headers (e.g., addresses, network IDs, etc.) may be added or subtracted by either the WAN handler 84 or the message dispatcher 80.

If the LAN is a non-TCP/IP network, the WAN handler 84 retrieves the message format of the non-TCP/IP network from the data stores 86, converts the TCP/IP addresses and information to the non-TCP/IP format, and creates a suitable WAN message to be sent to the message dispatcher 80 and the RF handler 82 for transmittal via the non-TCP/IP LAN to the electric meter 10.

In creating the message targeted to the electric meter 10 to be sent to the RF handler 82, the message dispatcher 80 utilizes the appropriate relay information from the data stores 86 in creating the packet relay address sequence in the message headers. This relay information, in some embodiments, may be based on routing calculations and may include one or more of the following: lowest path cost, lowest link cost(s), most robust routes, least number of hops, or well-established return paths to a LAN node.

Referring now to FIG. 9B, the message dispatcher 80 receives the WAN message from the WAN handler 84 and determines the request from the utility 76. The message dispatcher 80 determines that the end recipient or target is the electronic meter 10. The message dispatcher 80 then verifies the meter ID from the data stores 86, creates a RF message and routes the RF message to the RF handler 82. Further, as described herein, the message dispatcher 80 verifies that the message format received from the WAN handler 84 is compatible with the message format supported by the wireless LAN via which the electric meter 10 receives the targeted message from the gateway 72.

Referring now to FIG. 9C, the RF handler 82 receives the RF message from the message dispatcher 80, selects a proper RF channel, converts the RF message to a RF data stream, sends the RF data stream to the electric meter 10 over the LAN 74 and waits for a response. The electric meter 10 then responds by sending a RF data stream over the LAN 74 to the RF handler 82 of the gateway node 72. The RF handler 82 receives the RF data stream, creates a RF message from the RF data stream and routes the RF message to the message dispatcher 80. As shown in FIG. 9B, the message dispatcher 80 receives the RF message, determines the target utility for response from the data stores 86, creates a WAN message and routes the WAN message to the WAN handler 84. The WAN handler 84 receives the WAN message from the message dispatcher 80, converts the WAN message to a WAN data stream and sends the WAN data stream to the utility 76 over the fixed common carrier WAN 78, as shown in FIG. 9A, to complete the communication episode.

In alternative embodiments, such as the networked automatic meter reading data communication systems of FIGS. 6B and 6C, the message dispatcher 80 may select an indirect route to the target meter (node) via one or more intermediate nodes 10′ or 10″ based on information it has in its memory or in the data stores 86. Such information may include a relay table that specifies a relay path for transmitting packets to the nodes in the LAN and network condition information, which may prompt selection of indirect paths.

As described herein, the response from the electric meter 10 may be received by the RF handler 82 of the gateway node 72 via one or more intermediate nodes 10′ or 10″. However, such RF message may be identified by the message dispatcher 80 as the one sent by the responding source meter 10. The message dispatcher 80 may further analyze the route used by the incoming packet and compare it with the routing information stored in the data stores 86, and may use this information to update the relay table.

Any meter node 10 can perform the function of a gateway if it has connection over a WAN 78 to the utility 76, and is equipped with the WAN handler 84, message dispatcher 80, data stores 86, and scheduler 88. All nodes 10, 10′ and 10″ have an RF handler 82 since their transceiver 60 and communication microcontroller 58 are equipped to handle the function of a gateway RF handler. For example, as shown in FIG. 6B, source electric meter node 10 and intermediate electric meter node 10′ may have connections over a WAN 78 to the utility 76. In this way, the nodes 10 and 10′ may perform the function of a gateway.

The message dispatcher 80 receives the RF message from the meter 10, identifies the target utility (commodity service provider/node) and the characteristics of the WAN from the data stores 86, and creates a WAN message. The message dispatcher 80 also retrieves from the data stores 86 the characteristics of the LAN that relays the message from the meter 10. For example, the LAN may be a TCP/IP network or a non-TCP/IP network, and the WAN may be a TCP/IP network. If the LAN is a TCP/IP network, then the message format will stay the same, except some information in the headers (e.g., addresses, network IDs, etc.) may be added or subtracted by either the WAN handler 84 or the message dispatcher 80. The WAN message is then sent to the WAN handler 84 for sending it to the utility 76 via the WAN.

If the LAN is a non-TCP/IP network, the message dispatcher 80 retrieves the message format of the TCP/IP network from the data stores 86, and converts the received non-TCP/IP message format, with its address and ID information, to the TCP/IP format, and creates a suitable WAN message to be sent to the WAN handler 84. The WAN handler 84 receives the WAN message, checks the format to make sure the address and ID information are accurate, checks the TCP/IP message format created by the message dispatcher 80, and sends the WAN data stream to the utility 76 over the fixed common carrier WAN.

A communication episode can also be initiated by scheduled readings preprogrammed into the scheduler 88 of the gateway node 72 as shown in FIG. 9D. A list of scheduled reading times is preprogrammed into memory within the gateway node 72. The scheduler 88 runs periodically when a scheduled reading is due. When it is time for a scheduled reading, the scheduler 88 retrieves meter 10 information from the data stores 86, creates a RF message and routes the RF message to the RF handler 82, receives the RF message, selects a proper RF channel, converts the RF message to a RF data stream, sends the RF data stream to the electric meter 10 and waits for a response.

In creating the message to the electric meter 10, the scheduler 88 retrieves the appropriate network characteristics and ID information concerning the targeted electric meter 10 from the data stores 86. The appropriate network characteristics and ID information may also include identification of wireless LAN characteristics. In some embodiments, the wireless LAN may be a TCP/IP network. Yet, in other embodiments, the wireless LAN may be a non-TCP/IP network. In certain embodiments, the wireless LAN may support one of the IPv4 and IPv6 packet structures. The scheduler 88 accordingly formats the request message for the electric meter 10 in a format that is compatible with the wireless LAN.

In creating the message targeted to the electric meter 10 to be sent to the RF handler 82, the message dispatcher 80 utilizes the appropriate routing information from the data stores 86 in creating the packet relay address sequence in the message headers. This relay information, in some embodiments, may be based on routing calculations and may include one or more of the following: lowest path cost, lowest link cost(s), most robust routes, least number of hops, or well-established return paths to a LAN node.

The meter 10 then responds with a RF data stream to the RF handler 82. The RF handler 82 receives the RF data stream, creates a RF message from the RF data stream and routes the RF message to the message dispatcher 80. The message dispatcher 80 receives the RF message, determines the target utility for response from the data stores 86, creates a WAN message and routes the WAN message to the WAN handler 84. The WAN handler 84 receives the WAN message, converts the WAN message to a WAN data stream and sends the WAN data stream to the utility 76.

As described herein in conjunction with FIGS. 6B and 6C, in some embodiments the gateway node 72 may receive the responses and data from the meter 10 via one or more intermediate nodes 10′ or 10″, with the route pre-selected and set by the sending meter node 10, or determined by any of the intermediate nodes 10′ or 10″. The meter node 10 may choose which intermediate node 10′ or 10″ it wants to use to forward its packets to the gateway node 72 based on one or more of a stored routing table, prevailing network and traffic conditions, prevailing outage conditions, and other types of link information that identifies a particular neighboring meter node as an intermediate node for relaying the data packets.

In creating the WAN message and WAN data stream to the utility 76 via the WAN 78, the message dispatcher 80 retrieves the WAN characteristics from the data stores 86 concerning the particular message format supported by the WAN. If the format supported by the WAN 78 is the same as the format supported by the wireless LAN 74, via which the response message from the electric meter 10 is received by the gateway 72, then the message dispatcher 80 simply adjusts the address fields and forwards the message to the WAN for generating the WAN data stream. If the format used by the WAN is different the format supported by the wireless LAN 74, then the message dispatcher 80 reformats the electric meter message into a format that is supported by the WAN, in creating the WAN message and WAN data stream. In some embodiments, both the wireless LAN 74 and WAN 78 are TCP/IP networks. In other embodiments, the wireless LAN may be a non-TCP/IP network, while the WAN may be a TCP/IP network. In certain embodiments, the packet structure supported by both the wireless LAN 74 and the WAN 78 may be one of IPv4 and IPv6.

Therefore, for those skilled in the art, it will be understood that the WAN handler 84 and the message dispatcher 80 at the gateway 72 will ensure that the WAN message (to and from the utility 76 via the WAN 78) and the RF message (to and from the electric meter 10 via the wireless LAN 74) is properly formatted to be compatible with the formats supported by the WAN 78 and the wireless LAN 74. While in this embodiment, the functions are performed by the WAN handler 84 and the message dispatcher 80 and with information stored in the data stores 86, other methods and components may be used at the gateway 72 to accomplish the same objective of creating the WAN and RF messages to be compatible with the formats supported by the WAN and the wireless LAN.

Occasionally, the utility 76 may request data that is stored within the gateway node memory. In this case, the utility 76 initiates the communication episode by sending a WAN data stream to the WAN handler 84. The WAN handler 84 receives the WAN data stream, creates a WAN message, verifies the utility ID of the sender in the data stores 86 and routes the WAN message to the message dispatcher 80. As shown in FIG. 9B, the message dispatcher 80 receives the WAN message and determines the request from the utility 76. The message dispatcher 80 then determines the target of the message. If the data requested is stored in the gateway node memory, then the gateway node 72 performs the requested task, determines that the requesting utility is the target utility for a response, creates a WAN message and routes the WAN message to the WAN handler 84. The WAN handler 84 receives the WAN message, converts the WAN message to a WAN data stream and sends the WAN data stream to the utility 76. As described herein, the generated WAN message format is compatible with the format supported by the WAN 78, which may support one of IPv4 and IPv6.

The following type of communication episode may be one which is initiated by the electric meter 10. In this case, the meter 10 may detect an alarm outage or tamper condition and sends a RF data stream to the RF handler 82 of the gateway node 72. The RF handler 82 receives the RF data stream, creates a RF message from the RF data stream and routes the RF message to the message dispatcher 80. The message dispatcher 80 receives the RF message, determines the target utility for response from the data stores 86, creates a WAN message and routes the WAN message to the WAN handler 84. The WAN handler 84 receives the WAN message, converts the WAN message to a WAN data stream and sends the WAN data stream to the utility 76. The WAN message format is compatible with the message format supported by the WAN 78, which may support one of IPv4 and IPv6.

Thus, three different types of communication episodes can be accomplished within the automatic meter reading data communication system shown in FIGS. 8 and 9A-E. The automatic meter reading functions incorporated in electric meter 10 may include monthly usage readings, demand usage readings, outage detection and reporting, tamper detection and notification, load profiling, first and final meter readings, and virtual shutoff capability, among others.

FIG. 9D represents information or data that is preprogrammed into the gateway node's memory. Included within the memory is a list of scheduled reading times to be performed by the interface management unit. These reading times may correspond to monthly or weekly usage readings, etc.

FIG. 9E represents data or information stored in the gateway node's memory dealing with registered utility information and registered interface management unit information. This data includes the utility identification numbers of registered utilities, interface management unit identification numbers of registered interface management units, and other information for specific utilities and specific interface management units, so that the gateway node may communicate directly with the desired utility or correct electric meter. Further, information regarding the message formats and data structures supported by the WAN 78 and the wireless LAN 74 are also stored in the gateway memory, to facilitate easy and fast reformatting of WAN messages and wireless LAN RF messages that are targeted for the utility and the electric meter.

### Electronic Electric Meter Virtual Shut-Off Function

The virtual shut-off function of the electric meter 10 is used for situations such as a change of ownership where a utility service is to be temporarily inactive. When a residence is vacated there should not be any significant consumption of electricity at that location. If there is any meter movement, indicating unauthorized usage, the utility needs to be notified. The tamper switch 56 of the electric meter 10 provides a means of flagging and reporting meter movement beyond a preset threshold value.

Activation of the virtual shut-off mode is accomplished through the “set virtual threshold” message, defined as a meter count which the electric meter is riot to exceed. In order to know where to set the threshold it is necessary to know the present meter count. The gateway node reads the meter count, adds whatever offset is deemed appropriate, sends the result to the electric meter as a “set virtual shut-off” message. The electric meter will then enable the virtual shut-off function. The electric meter then accumulates the meter counts. If the meter count is greater than the preset threshold value then the electric meter sends a “send alarm” message to the gateway node until a “clear error code” message is issued in response by the gateway node. However, if the meter count is less than the preset threshold value then the electric meter continues to monitor the meter count. The virtual shut-off function may be canceled at any time by a “clear error code” message from the gateway node.

If the meter count in the meter does not exceed the preset threshold value at any given sampling time, then the meter continues to count until the preset threshold count is attained or until operation in the virtual shut-off mode is canceled.

### Gateway Node

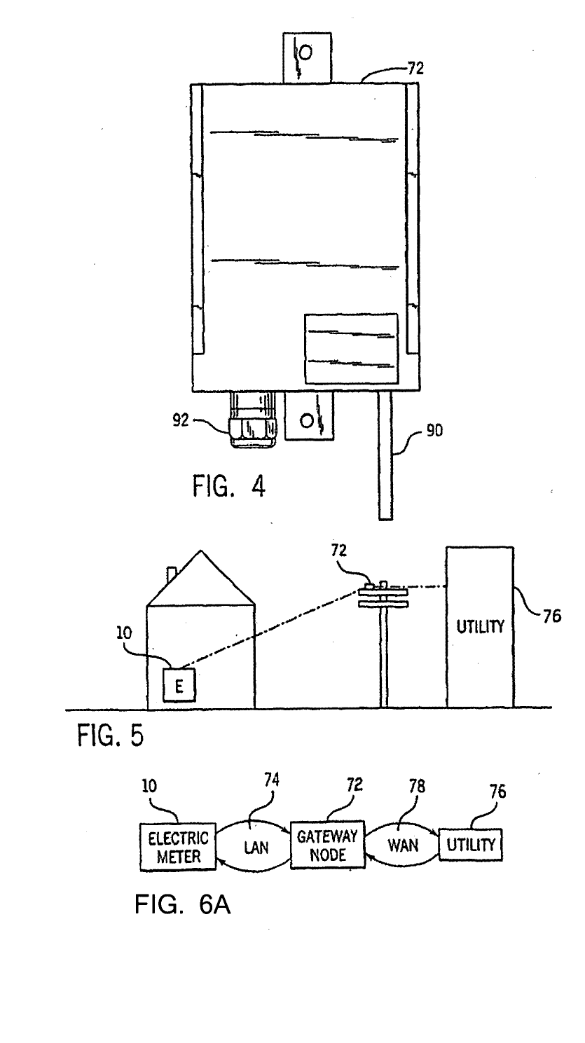

The gateway node 72 is shown in FIG. 4. The gateway node 72 is typically located on top of a power pole or other elevated location so that it may act as a communication node between LAN 74 and WAN 78. The gateway node 72 includes an antenna 90 for receiving and transmitting data over the RF communication links, and a power line carrier connector 92 for connecting a power line to power the gateway node 72. The gateway node 72 may also be solar powered. The compact design allows for easy placement on any existing utility pole or similarly situated elevated location. The gateway node 72 provides end-to-end communications from the meter 10 to the utility 76. The wireless gateway node 72 interfaces with the electric meter 10 over a two-way wireless 900 MHz spread spectrum LAN 74. Also, the gateway node 72 will interface and be compatible with any commercially available WAN 78 for communicating commodity usage and power quality information with the utility. The gateway node 72 may be field programmable to meet a variety of data reporting needs.

The gateway node 72 receives data requests from the utility, interrogates the meter 10 and forwards commodity usage information, as well as power quality information, over the WAN 78 to the utility 76. The gateway node 72 exchanges data with certain, predetermined, meters for which it is responsible, and “listens” for signals from those meters. The gateway node 72 does not store data for extended periods, thus minimizing security risks. The gateway node's RF communication range is typically one mile.

A wide variety of fixed WAN communication systems such as those employed with two-way pagers, cellular telephones, conventional telephones, narrowband PCS, cellular digital packet data (CDPD) systems, WiMax, and satellites may be used to communicate data between the gateway nodes and the utility. The data communication system may utilize channelized direct sequence 900 MHz spread spectrum transmissions for communicating between the meters and gateway nodes. Other modulation schemes, such as frequency hopping spread spectrum and time-division multiple access, may also be used. An exemplary gateway node includes the Silver Spring Network Gateway node that uses the AxisPortal V2.2 and common carrier wide area networks such as telephone, code-division multiple access (CDMA) cellular networks. Another exemplary gateway node includes the Silver Spring Network AxisGate Network Gateway. In some embodiments, the relay node without the meter interface electronics, may be packaged and mounted in a manner similar to the gateway node.

### Circuitry of Gateway Node

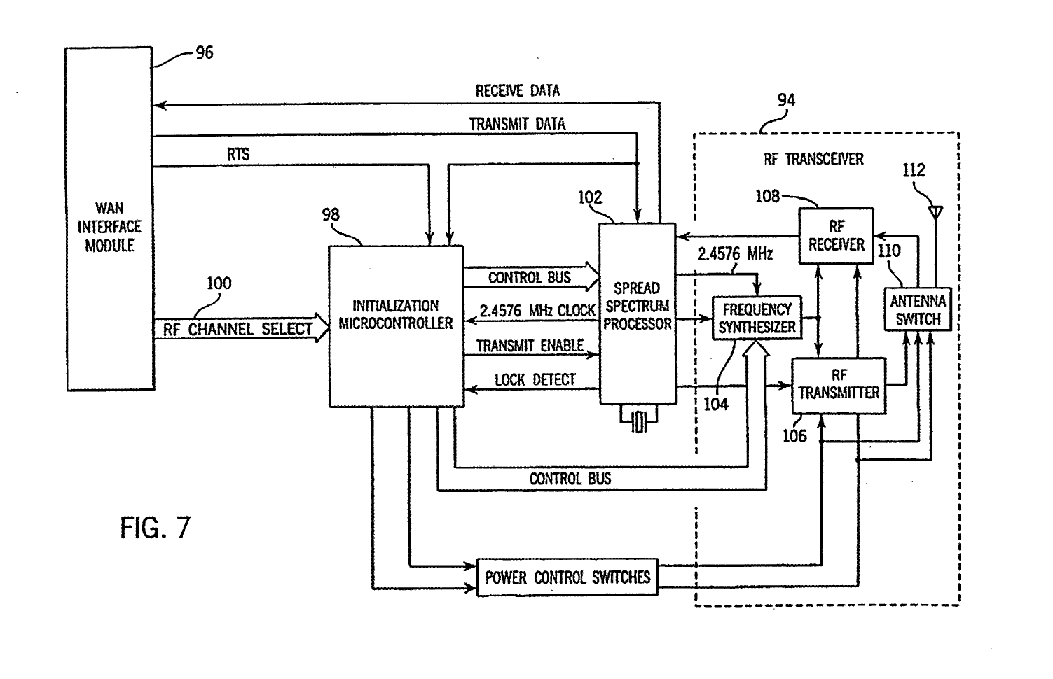

FIG. 7 shows a block diagram of the gateway node circuitry. The RF transceiver section 94 of gateway node 72 is the same as the RF transceiver section 60 of electric meter 10 and certain portions thereof, such as the spread spectrum processor and frequency synthesizer, are shown in greater detail in FIG. 7. The gateway node 72 includes a WAN interface module 96 which may incorporate electronic circuitry for a two-way pager, PLC, satellite, cellular telephone, fiber optics, CDPD system, PCS, or other commercially available fixed WAN system. The construction of WAN interface module 96 and initialization microcontroller 98 may change depending on the desired WAN interface. RF channel selection is accomplished through a RF channel select bus 100 which interfaces directly with the initialization microcontroller 98.

Initialization microcontroller 98 controls all node functions including programming spread spectrum processor 102, RF channel selection in frequency synthesizer 104 of RF transceiver 94, transmit/receive switching, and detecting failures in WAN interface module 96.

Upon power up, initialization microcontroller 98 will program the internal registers of spread spectrum processor 102, read the RF channel selection from the electric meter 10, and set the system for communication at the frequency corresponding to the channel selected by the meter 10.

Selection of the RF channel used for transmission and reception is accomplished via the RF channel select bus 100 to initialization microcontroller 98. Valid channel numbers range from 0 to 23. In order to minimize a possibility of noise on the input to initialization microcontroller 98 causing false channel switching, the inputs have been debounced through software. Channel selection data must be present and stable on the inputs to initialization microcontroller 98 for approximately 250 μs before the initialization microcontroller will accept it and initiate a channel change. After the channel change has been initiated, it takes about 600 μs for frequency synthesizer 104 of RF transceiver 94 to receive the programming data and for the oscillators in the frequency synthesizer to settle to the changed frequency. Channel selection may only be completed while gateway node 72 is in the receive mode. If the RF channel select lines are changed during the transmit mode the change will not take effect until after the gateway node has been returned to the receive mode.

Once initial parameters are established, initialization microcontroller 98 begins its monitoring functions. When gateway node 72 is in the receive mode, the initialization microcontroller 98 continuously monitors RF channel select bus 100 to determine if a channel change is to be implemented.

For receiving data, gateway node 72 monitors the electric meter 10 to determine the presence of data. Some additional handshaking hardware may be required to sense the presence of a spread spectrum signal.

An alarm message is sent automatically by electric meter 10 in the event of a tamper or alarm condition, such as a power outage. The message is sent periodically until the error has cleared. Gateway node 72 must know how many bytes of data it is expecting to see and count them as they come in. When the proper number of bytes is received, reception is deemed complete and the message is processed. Any deviation from the anticipated number of received bytes may be assumed to be an erroneous message.

During the transmit mode of gateway node 72, initialization microcontroller 98 monitors the data line to detect idle conditions, start bits, and stop bits. This is done to prevent gateway node 72 from continuously transmitting meaningless information in the event a failure of WAN interface module 96 occurs and also to prevent erroneous trailing edge data from being sent which cannot terminate transmissions in a timely fashion. The initialization microcontroller 98 will not enable RF transmitter 106 of RF transceiver 94 unless the data line is in the invalid idle state when communication is initiated.

A second watchdog function of initialization microcontroller 98 when gateway node 72 is in the transmit mode is to test for valid start and stop bits in the serial data stream being transmitted. This ensures that data is read correctly. The first start bit is defined as the first falling edge of serial data after it has entered the idle stage. All further timing during that communication episode is referenced from that start bit. Timing for the location of a stop bit is measured from the leading edge of a start bit for that particular byte of data. Initialization microcontroller 98 measures an interval which is 9.5 bit times from that start bit edge and then looks for a stop bit. Similarly, a timer of 1 bit interval is started from the 9.5 bit point to look for the next start bit. If the following start bit does not assert itself within 1 bit time of a 9.5 bit time marker a failure is declared. The response to a failure condition is to disable RF transmitter 106.

Communication to and from electric meter 10 may be carried out in one of a preselected number, for example 24 channels in a preselected frequency band, for example 902-928 MHz. The meter 10 receives data and transmits a response on a single RF channel which is the same for both transmit and receive operation. As hereinafter described, the specific RF channel used for communication may be chosen during commissioning and installation of the unit and loaded into memory. The RF channel may be chosen to be different from the operating channels of other, adjacent interface management units, thereby to prevent two or more interface management units from responding to the same interrogation signal. The set RF channels are reconfigurable.

Frequency synthesizer 104 performs the modulation and demodulation of the spread spectrum data provided by spread spectrum processor 60 onto a carrier signal and demodulation of such data from the carrier signal. The RF transceiver has separate transmitter 106 and receiver 108 sections fed from frequency synthesizer 104.

The output of the spread spectrum processor to frequency synthesizer comprises a 2.4576 MHz reference frequency signal in conductor and a PN encoded base band signal in conductor. Frequency synthesizer may comprise a National Semiconductor LMX2332A Dual Frequency Synthesizer.

The direct sequence modulation technique employed by frequency synthesizer may use a high rate binary code (PN code) to modulate the base band signal. The resulting spread signal is used to modulate the transmitter's RF carrier signal. The spreading code is a fixed length PN sequence of bits, called chips, which is constantly being recycled. The pseudo-random nature of the sequence achieves the desired signal spreading, and the fixed sequence allows the code to be replicated in the receiver for recovery of the signal. Therefore, in direct sequence, the base band signal is modulated with the PN code spreading function, and the carrier is modulated to produce the wide band signal.

Minimum shift keying (MSK) modulation may be used in order to allow reliable communications, efficient use of the radio spectrum, and to keep the component count and power consumption low. The modulation performed by frequency synthesizer 72 is minimum shift keying (MSK) at a chip rate of 819.2 Kchips per second, yielding a transmission with a 6 dB instantaneous bandwidth of 670.5 KHz.

The receiver bandwidth of this spread spectrum communication technique is nominally 1 MHz, with a minimum bandwidth of 900 KHz. Frequency resolution of the frequency synthesizer is 0.2048 MHz, which will be used to channelize the band into 24 channels spaced a minimum of 1.024 MHz apart. This frequency channelization is used to minimize interference between interface management units within a common communication range as well as providing growth for future, advanced features associated with the data communication system.

Frequency control of the RF related oscillators in the system may be provided by dual phase locked loop (PLL) circuitry within frequency synthesizer. The phase locked loops are controlled and programmed by initialization microcontroller via a serial programming control bus, FIG. 7. The frequency synthesizer produces two RF signals which are mixed together in various combinations to produce a transmission carrier and to demodulate incoming RF signals. The transmission carrier is based on frequencies in the 782-807 MHz range and the demodulation signal is based on frequencies in the 792-817 MHz range. These signals may be referred to as RF transmit and RF receive local oscillation signals.

Table 1 is a summary of the transmission channel frequencies and associated frequency synthesizer transmit/receive outputs. The signals in the table are provided by the two PLL sections in the dual frequency synthesizer.

TABLE 1

| Channel | Channel | Transmit Local | Receive Local |
|---|---|---|---|
| Number | Frequency (MHz) | Oscillation (MHz) | Oscillation (MHz) |
| 0 | 902.7584 | 782.3360 | 792.1664 |
| 1 | 903.7824 | 783.3600 | 793.1904 |
| 2 | 904.8064 | 784.3840 | 794.2144 |
| 3 | 905.8304 | 785.4080 | 795.2384 |
| 4 | 906.8544 | 786.4320 | 796.2624 |
| 5 | 907.8784 | 787.4560 | 797.2864 |
| 6 | 908.9024 | 788.4800 | 798.3104 |
| 7 | 910.1312 | 789.7088 | 799.5392 |
| 8 | 911.1552 | 790.7328 | 800.5632 |
| 9 | 912.1792 | 791.7568 | 801.5872 |
| 10 | 913.2032 | 792.7808 | 802.6112 |
| 11 | 914.2272 | 793.8048 | 803.6352 |
| 12 | 915.2512 | 794.8288 | 804.6592 |
| 13 | 916.2752 | 795.8528 | 805.6832 |
| 14 | 917.2992 | 796.8768 | 806.7072 |
| 15 | 918.3232 | 797.9008 | 807.7312 |
| 16 | 919.9616 | 799.5392 | 809.3696 |
| 17 | 920.9856 | 800.5632 | 810.3936 |
| 18 | 922.0096 | 801.5872 | 811.4176 |
| 19 | 923.2384 | 802.8160 | 812.6464 |
| 20 | 924.2624 | 803.8400 | 813.6704 |
| 21 | 925.2864 | 804.8640 | 814.6944 |
| 22 | 926.3104 | 805.8880 | 815.7184 |
| 23 | 927.3344 | 806.9120 | 816.7424 |

A third signal, which is fixed at 120.4224 MHz, is also supplied by the dual frequency synthesizer. This signal is referred to as the intermediate frequency (IF) local oscillation signal.

In transmission mode, frequency synthesizer 104 provides a signal having a frequency in the 782-807 MHz range, modulated with the data to be transmitted. RF transmitter section 106 mixes the signal with the fixed frequency IF local oscillator signal. This results in a RF signal which ranges between 902 MHz and 928 MHz. The signal is filtered to reduce harmonics and out of band signals, amplified and supplied to antenna switch 110 and antenna 112.

It is recognized that other equivalents, alternatives, and modifications aside from those expressly stated, are possible and are within the scope of the appended claims.

What is claimed is:

1. A method for relaying meter commodity information to a target node in an automatic meter reading (AMR) data communication network, the method comprising:
receiving, at a first meter node in the AMR network, a data packet including the meter commodity information, wherein the first meter node comprises a meter configured to measure commodity characteristic data;
determining, at the first meter node, whether the first meter node is the target node based on identifier information in the data packet; and
if the first meter node is not the target node, relaying the data packet to a second node in the AMR network.

2. The method of claim 1, wherein the second node comprises another meter node configured to measure commodity characteristic data, a repeater node, a gateway node configured to communicate with a commodity provider, or a commodity provider node.

3. The method of claim 1, wherein the second node comprises the target node.

4. The method of claim 1, wherein the step of relaying comprises:
determining, at the first meter node, whether the data packet specifies a path for relaying the data packet to the target node.

5. The method of claim 4, further comprising:
if the data packet specifies a relay path, relaying the data packet to the second node in the AMR network in accordance with a next node identified in the specified relay path.

6. The method of claim 4, further comprising:
if the data packet specifies a relay path, evaluating, at the first meter node, a next node identified in the specified relay path to determine whether to relay the data packet to the next node identified in the specified relay path;
identifying, at the first meter node, an alternate next node when the first meter node determines not to relay the data packet to the next node identified in the specified relay path; and
relaying the data packet to the second node in the AMR network in accordance with the alternate next node instead of the next node identified in the specified relay path.

7. The method of claim 6, wherein the step of identifying the alternate next node comprises:
replacing the next node identified in the specified relay path with the alternate next node.

8. The method of claim 4, further comprising:
if the data packet specifies a relay path, evaluating, at the first meter node, whether to relay the data packet in accordance with the specified relay path;
determining an alternate path for relaying the data packet to the target node when the first meter node determines not to the relay the data packet in accordance with the specified relay path; and
relaying the data packet to the second node in the AMR network in accordance with the alternate relay path.

9. The method of claim 4, further comprising:
if the data packet does not specify a relay path, determining, at the first meter node, a path for relaying the data packet to the target node; and
relaying the data packet to the second node in the AMR network in accordance with the relay path determined at the first meter node.

10. The method of claim 9, wherein the step of determining the relay path comprises:
specifying the relay path determined at the first meter node in a header of the data packet.

11. The method of claim 9, wherein the step of determining the relay path comprises:
determining the relay path based on one or more of path cost information, path reliability information, past path performance information, and network conditions information.

12. The method of claim 1, wherein the AMR network comprises a first AMR network supporting a first communication format, the first meter node belongs to the first AMR network and the first meter node also belongs to a second AMR network supporting a second communication format, and the second node belongs to either the first AMR network or the second AMR network, and wherein the step of relaying the data packet to the second node comprises:
converting the data packet, at the first meter node, from the first format to the second format when the first meter node receives the data packet over the first AMR network and relays the data packet over the second AMR network to the second node; and
converting the data packet, at the first meter node, from the second format to the first format when the first meter node receives the data packet over the second AMR network and relays the data packet over the first AMR network to the second node.

13. The method of claim 1, wherein the step of relaying the data packet to the second node comprises:
recreating a header of the data packet by removing identifier information of the first meter node and including identifier information of the second node.

14. The method of claim 1, further comprising:
if the first meter node is the target node, processing, at the first meter node, the meter commodity information included in the data packet.

15. A meter for relaying meter commodity information to a target node in an automatic meter reading (AMR) data communication network having the meter as a first meter node, the meter comprising:
means for measuring commodity characteristic data;
means for receiving a data packet including the meter commodity information;
means for processing data packets, wherein the processing means determines whether the first meter node is the target node based on identifier information in the data packet; and
means for relaying the data packet to a second node in the AMR network if the first meter node is not the target node.

16. The meter of claim 15, wherein the processing means determines whether the data packet specifies a path for relaying the data packet to the target node.

17. The meter of claim 16, wherein, if the data packet specifies a relay path, the relaying means relays the data packet to the second node in the AMR network in accordance with a next node identified in the specified relay path.

18. The meter of claim 16, wherein, if the data packet specifies a relay path, the processing means evaluates a next node identified in the specified relay path to determine whether to relay the data packet to the next node identified in the specified relay path, and identifies an alternate next node when the processing means determines not to relay the data packet to the next node identified in the specified relay path, and
wherein the relaying means relays the data packet to the second node in the AMR network in accordance with the alternate next node instead of the next node identified in the specified relay path.

19. The meter of claim 16, wherein, if the data packet specifies a relay path, the processing means evaluates whether to relay the data packet in accordance with the specified relay path, and determines an alternate path for relaying the data packet to the target node when the processing means determines not to the relay the data packet in accordance with the specified relay path; and
wherein the relaying means relays the data packet to the second node in the AMR network in accordance with the alternate relay path.

20. The meter of claim 16, wherein, if the data packet does not specify a relay path, the processing means determines a path for relaying the data packet to the target node, and
wherein the relaying means relays the data packet to the second node in the AMR network in accordance with the relay path determined by the processing means.

21. The meter of claim 15, wherein the AMR network comprises a first AMR network supporting a first communication format, the first meter node belongs to the first AMR network and the first meter node also belongs to a second AMR network supporting a second communication format, and the second node belongs to either the first AMR network or the second AMR network, and wherein the meter further comprises:
means for converting the data packet from the first format to the second format, when the first meter node receives the data packet from the first AMR network and relays the data packet over the second AMR network to the second node, and from the second format to the first format, when the first meter node receives the data packet from the second AMR network and relays the data packet over the first AMR network to the second node.

22. The meter of claim 15, wherein, if the first meter node is the target node, the processing means processes the meter commodity information included in the data packet.

23. A meter for relaying meter commodity information to a target node in an automatic meter reading (AMR) data communication network having the meter as a first meter node, the meter comprising:
a measurement module configured to measure commodity characteristic data;
a communications module configured to transmit and receive data packets, wherein the communications module receives a data packet including the meter commodity information; and
a processing module configured to process data packets, wherein the processing module determines whether the first meter node is the target node based on identifier information included in the received data packet, and wherein the communications module relays the data packet to a second node in the AMR network if the first meter node is not the target node.

24. The meter of claim 23, wherein the processing module determines whether the received data packet specifies a path for relaying the data packet to the target node.

25. The meter of claim 24, wherein, if the data packet specifies a relay path, the communications module relays the data packet to the second node in the AMR network in accordance with a next node identified in the specified relay path.

26. The meter of claim 24, wherein, if the data packet specifies a relay path, the processing module evaluates a next node identified in the specified relay path to determine whether to relay the data packet to the next node identified in the specified relay path, and identifies an alternate next node when the processing module determines not to relay the data packet to the next node identified in the specified relay path, and
wherein the communications module relays the data packet to the second node in the AMR network in accordance with the alternate next node instead of the next node identified in the specified relay path.

27. The meter of claim 24, wherein, if the data packet specifies a relay path, the processing module evaluates whether to relay the data packet in accordance with the specified relay path, and determines an alternate path for relaying the data packet to the target node when the processing module determines not to the relay the data packet in accordance with the specified relay path; and
wherein the communications module relays the data packet to the second node in the AMR network in accordance with the alternate relay path.

28. The meter of claim 24, wherein, if the data packet does not specify a relay path, the processing module determines a path for relaying the data packet to the target node, and
wherein the communications module relays the data packet to the second node in the AMR network in accordance with the relay path determined by the processing module.

29. The meter of claim 23, wherein the AMR network comprises a first AMR network supporting a first communication format, the first meter node belongs to the first AMR network and the first meter node also belongs to a second AMR network supporting a second communication format, and the second node belongs to either the first AMR network or the second AMR network, and
wherein the processing module converts the data packet from the first format to the second format, when the first meter node receives the data packet from the first AMR network and relays the data packet over the second AMR network to the second node, and from the second format to the first format, when the first meter node receives the data packet from the second AMR network and relays the data packet over the first AMR network to the second node.

30. The meter of claim 23, wherein, if the first meter node is the target node, the processing module processes the meter commodity information included in the data packet.

31. An automatic meter reading (AMR) data communication network for relaying meter commodity information, comprising:
a commodity provider node;
a gateway node configured to communicate with the commodity provider node; and
a plurality of meter nodes configured to measure commodity characteristic data and communicate with the gateway node and with other meter nodes,
wherein a source node of the meter nodes generates a data packet that includes meter commodity information to be relayed to the commodity provider node, and when a first meter node of the meter nodes receives the source data packet, the first meter node relays the source data packet to a second node of the AMR network.

32. The AMR network of claim 31, wherein the second node comprises another one of the meter nodes configured to measure commodity characteristic data, a repeater node, the gateway node, or the commodity provider node.

33. The AMR network of claim 31, wherein the first meter node determines whether the data packet specifies a relay path comprising one or more hops for relaying the source data packet to the commodity provider node, each hop comprising one of the meter nodes or the gateway node.

34. The AMR network of claim 33, wherein, if the source data packet specifies a relay path, the first meter node relays the source data packet to the second node in the AMR network in accordance with a next node identified in the specified relay path.

35. The AMR network of claim 33, wherein, if the source data packet specifies a relay path, the first meter node evaluates a next node identified in the specified relay path to determine whether to relay the source data packet to the next node identified in the specified relay path, identifies an alternate next node when the first meter node determines not to relay the source data packet to the next node identified in the specified relay path, and relays the source data packet to the second node in the AMR network in accordance with the alternate next node instead of the next node identified in the specified relay path.

36. The AMR network of claim 35, wherein the first meter node replaces the next node identified in the specified relay path with the alternate next node.

37. The AMR network of claim 33, wherein, if the source data packet specifies a relay path, the first meter node evaluates whether to relay the data packet in accordance with the specified relay path, determines an alternate path for relaying the data packet to the commodity provider node when the first meter node determines not to the relay the data packet in accordance with the relay path specified by the source node, and relays the source data packet to the second node in the AMR network in accordance with the alternate relay path.

38. The AMR network of claim 33, wherein, if the source data packet does not specify a relay path, the first meter node determines a relay path comprising one or more hops for relaying the source data packet to the commodity provider node, each hop comprising one of the meter nodes or the gateway node, and relays the source data packet to the second node in the AMR network in accordance with the relay path determined at the first meter node.

39. The AMR network of claim 38, wherein the first meter node determines the relay path when the first meter node has been authorized to determine a relay path.

40. The AMR network of claim 38, wherein the first meter node specifies the relay path determined at the first meter node in a header of the data packet.

41. The AMR network of claim 38, wherein the first meter node determines the relay path based on one or more of path cost information, path reliability information, past path performance information, and network conditions information.

42. The AMR network of claim 38, wherein at least one of the hops of the relay path is selected from a predefined subset of the meter nodes.

43. The AMR network of claim 42, wherein the predefined subset of the meter nodes includes preferred neighboring nodes selected by the first meter node based on a quality characteristic of the meter nodes.

44. The AMR network of claim 42, wherein the predefined subset of the meter nodes includes preferred neighboring nodes assigned by the gateway node.

45. The AMR network of claim 31, wherein the AMR network comprises:
a first network supporting a first communication format for communications between the source node and the gateway node; and
a second network supporting a second communication format for communications between the gateway node and the commodity provider node,
wherein the gateway node is configured to convert the source data packet from the first format to the second format and relay the converted source data packet over the second network to the commodity provider node, and
wherein the gateway node is configured to convert a data packet received from the commodity provider node from the second format to the first format and relay the converted commodity provider data packet over the first network to the source meter node.

46. The AMR network of claim 31, wherein when the gateway node receives a data packet from the commodity provider node, the gateway node determines a relay path comprising one or more hops for relaying the commodity provider data packet to the source node, each hop of the relay path comprising one of the meter nodes or the source node.

47. The AMR network of claim 46, wherein when the first meter node receives the commodity provider data packet from the gateway node, the first meter node determines whether to relay the commodity provider data packet in accordance with the relay path determined at the gateway node or in accordance with a new relay path, determined at the first meter node, comprising one or more hops for relaying the commodity provider data packet to the source node, each hop of the new relay path comprising one of the meter nodes or the source node.

48. The AMR network of claim 31, wherein at least one of the meter nodes includes a communications interface module configured to communicate directly with the commodity provider node, wherein the communications interface module includes one of a personal communication services (PCS) communications interface module, a power line carrier (PLC) communications interface module, a local area network (LAN) communications interface module, and a wide area network (WAN) communications interface module.

49. The AMR network of claim 48, wherein when the meter node communicates directly with the commodity provider node using the communications interface module, the meter node appends to the source data packet identification information for the meter node and request information.
